(19) United States
(12) Patent Application Publication
(10) Pub. No.: US 2026/0163379 A1
(43) Pub. Date: Jun. 11, 2026

(54) INTEGRATED ENERGY RESOURCES AND COMMUNICATIONS NETWORK

(71) Applicant: NextGen Energy Partners, Houston, TX (US)

(72) Inventor: Kimberly Ann JOHNSTON, Houston, TX (US)

(21) Appl. No.: 19/410,910

(22) Filed: Dec. 5, 2025

Related U.S. Application Data
(60) Provisional application No. 63/729,090, filed on Dec. 6, 2024.

(51) Int. Cl. H02J 3/466; H02J 3/28; H02J 3/38

(52) U.S. Cl. CPC H02J 3/466; H02J 3/28; H02J 3/381; H02J 2103/35

(57) ABSTRACT

Example implementations include a method, apparatus and computer-readable medium for an integrated energy resources and communications network, comprising identifying a plurality of microgrids and distributed energy resources (DERs) in connection with one or more utility grids. The implementations further include generating a prioritization plan for the plurality of microgrids and DERs based on criteria including a community energy needs factor, a grid congestion level, and a resilience enhancement potential factor. Additionally, the implementations further include integrating the plurality of microgrids and DERs with one or more distribution systems of the one or more utility grids according to the prioritization plan to facilitate deployment of the plurality of microgrids and DERs. Additionally, the implementations further include deploying the plurality of microgrids and DERs via the one or more distribution systems of the one or more utility grids to offset energy demands on the one or more utility grids.

### CROSS-REFERENCE TO RELATED APPLICATIONS

This application claims the benefit of U.S. Provisional Patent Application No. 63/729,090, filed December 6, 2024, entitled “INTEGRATED ENERGY RESOURCES AND COMMUNICATIONS NETWORK”, the contents of which are incorporated by reference herein in their entireties.

### BACKGROUND

### Technical Field

The described aspects relate to an electrical power grid, and more particular descriptions are directed to integrated energy resources and communications network.

### Introduction

Traditional utility power grids include a centralized power source (such as a coal-powered generator, a nuclear-power generator, a hydroelectric dam generator, wind farm, or others) and centralized management. The “grid” may connect to other power sources as well so that power can be shared across grid infrastructure from different power sources at a macro-level. However, traditionally, the grid includes a substantial amount of infrastructure, such as utility power lines with associated poles and towers, as well as substations to distribute the power. The grid is traditionally based on a massive generator that can provide enough power to satisfy peak demand of interconnected consumers. A consumer can include a dwelling place, a business, a cellphone tower or other utility box, or other user of power. The different consumers can have different peak demands, from the smallest user of energy to large businesses that have high power demands for heavy commercial equipment.

Traditional grid infrastructure is expensive to build and maintain. Furthermore, it requires the pushing of energy out from the central power source to the consumers, which can be hundreds of miles away. The substations and other infrastructure such as neighborhood transformers are controlled by the centralized management to keep voltages in-phase with current delivered on the grid, and keep voltage levels at regulated levels. Typically, motorized equipment drawing power from the grid will cause a degradation of power factor of the grid. On a macro scale, the grid management has attempted to control the power factor disturbance of the grid due to such motorized equipment. Newer switching power supply designs in modern electronics further complicate the power factor and voltage regulation of the grid by requiring reactive power and introducing noise back onto the grid.

Consumers typically only become aware of the finite nature of energy when one of two things happens: either power is suddenly lost during a blackout; or, the use of energy becomes very obvious in the form of a confusingly high utility bill. Otherwise, people tend to take energy for granted and expect public utility companies to worry about all aspects of it. However, as the demand for energy grows, debates also grow about how to meet the demand.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method for an integrated energy resources and communications network, comprising identifying a plurality of microgrids and distributed energy resources (DERs) to serve as a network of hubs for energy resilient operations (HERO) in connection with one or more utility grids. The method further includes generating a prioritization plan for the plurality of microgrids and DERs based on criteria including a community energy needs factor, a grid congestion level, and a resilience enhancement potential factor. Additionally, the method further includes integrating the plurality of microgrids and DERs with one or more distribution systems of the one or more utility grids according to the prioritization plan to facilitate deployment of the plurality of microgrids and DERs. Additionally, the method further includes deploying the plurality of microgrids and DERs via the one or more distribution systems of the one or more utility grids to offset energy demands on the one or more utility grids.

Another example aspect includes an apparatus for an integrated energy resources and communications network, comprising one or more memories and one or more processors coupled with one or more memories and configured to perform, individually or in any combination, the follow actions. The one or more processors are configured to identify a plurality of microgrids and DERs to serve as a network of HERO in connection with one or more utility grids. The one or more processors are further configured to generate a prioritization plan for the plurality of microgrids and DERs based on criteria including a community energy needs factor, a grid congestion level, and a resilience enhancement potential factor. Additionally, the one or more processors are further configured to integrate the plurality of microgrids and DERs with one or more distribution systems of the one or more utility grids according to the prioritization plan to facilitate deployment of the plurality of microgrids and DERs. Additionally, the one or more processors are further configured to deploy the plurality of microgrids and DERs via the one or more distribution systems of the one or more utility grids to offset energy demands on the one or more utility grids.

Another example aspect includes an apparatus for an integrated energy resources and communications network, comprising means for identifying a plurality of microgrids and DERs to serve as a network of HERO in connection with one or more utility grids. The apparatus further includes means for generating a prioritization plan for the plurality of microgrids and DERs based on criteria including a community energy needs factor, a grid congestion level, and a resilience enhancement potential factor. Additionally, the apparatus further includes means for integrating the plurality of microgrids and DERs with one or more distribution systems of the one or more utility grids according to the prioritization plan to facilitate deployment of the plurality of microgrids and DERs. Additionally, the apparatus further includes means for deploying the plurality of microgrids and DERs via the one or more distribution systems of the one or more utility grids to offset energy demands on the one or more utility grids.

Another example aspect includes a computer-readable medium having instructions stored thereon for an integrated energy resources and communications network, wherein the instructions are executable by one or more processors to identify a plurality of microgrids and DERs to serve as a network of HERO in connection with one or more utility grids. The instructions are further executable to generate a prioritization plan for the plurality of microgrids and DERs based on criteria including a community energy needs factor, a grid congestion level, and a resilience enhancement potential factor. Additionally, the instructions are further executable to integrate the plurality of microgrids and DERs with one or more distribution systems of the one or more utility grids according to the prioritization plan to facilitate deployment of the plurality of microgrids and DERs. Additionally, the instructions are further executable to deploy the plurality of microgrids and DERs via the one or more distribution systems of the one or more utility grids to offset energy demands on the one or more utility grids.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a block diagram of an example utility grid system with integrated energy resources, in accordance with various implementations of the present disclosure;

FIG. 2 is a block diagram of an example centralized generation system and distributed generation system, in accordance with various implementations of the present disclosure;

FIG. 3 is a block diagram of an example microgrid, in accordance with various implementations of the present disclosure;

FIG. 4 is a block diagram of an example virtual power plant(s) (VPP(s)), in accordance with various implementations of the present disclosure;

FIG. 5 is a block diagram of an example of a computer device having components configured to perform a method for an integrated energy resources and communications network;

FIG. 6 is a flowchart of an example of a method for an integrated energy resources and communications network;

FIG. 7 is a flowchart of additional aspects of the method of FIG. 6;

FIG. 8 is a flowchart of additional aspects of the method of FIG. 6;

FIG. 9 is a flowchart of additional aspects of the method of FIG. 6;

FIG. 10 is a flowchart of additional aspects of the method of FIG. 6;

FIG. 11 is a flowchart of additional aspects of the method of FIG. 6;

FIG. 12 is a flowchart of additional aspects of the method of FIG. 6; and

FIG. 13 is a flowchart of additional aspects of the method of FIG. 6.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to an integrated energy resources and communications network, and more specifically to aggregated and local management of microgrids and distributed energy resources.

The United States and global regions are increasingly vulnerable to energy security challenges driven by a confluence of factors. Rising extreme weather events, accelerated adoption of renewable energy sources, rapid demand for electrification, and aggressive decarbonization targets are all contributing to this crisis. The existing centralized and aging power infrastructure was not designed to withstand these modern challenges, leaving it ill-equipped to handle the demands of today and the future.

Over the past five years, from 2019 to 2023, the United States has faced 102 significant events that have collectively cost $617 billion, averaging $125 billion annually. In 2022 alone, U.S. consumers spent a staggering $1.7 trillion on energy, which accounted for 6.7% of the nation's GDP. This translated to an annual energy cost of $5,159 per person, marking a 30% increase from the previous year, 2021. Currently, there is nearly 2,600 gigawatts (GW) of total generation and storage capacity seeking connection to the grid, with over 95% of this capacity being zero-carbon resources such as solar, wind, and storage.

The North American Electric Reliability Corporation (NERC) forecasts a growth of 78 gigawatts (GW) in winter peak demand over the next decade, a significant increase from the roughly 40 GW forecasted just two years ago. In response to these challenges, most U.S. states have adopted renewable portfolio standards (RPS) and/or clean energy standards (CES). Additionally, 45% of Fortune Global 500 companies have committed to achieving net-zero emissions by 2050, underscoring the urgent need for a robust and resilient energy infrastructure.

The present implementations set forth a modernized electricity network. In an aspect, the system is configured to deliver more abundant, reliable, and affordable energy, which is essential for the current and future well-being of humanity, environmental health, and economic vitality. By focusing on a systems-based approach, the system aims to address the multifaceted issues facing today's energy infrastructure, ensuring that the solutions are both comprehensive and sustainable.

In an aspect, the system involves integrated community energy planning, which uses data-driven assessments and studies to inform grid performance needs and customer priorities across different geographic zones. This approach allows for tailored solutions that effectively meet the diverse energy demands of various communities. Additionally, the network includes Hubs for Energy Resilient Operations (HERO Hubs), which are decentralized and modernized networks of microgrids, distributed energy resources, and virtual power plants. These hubs are integrated with utility-owned electric transmission and distribution systems, enhancing the monitoring, operation, and resilience of energy resources. Furthermore, the network ensures emergency operations connectivity by interconnecting HERO Hubs with regional emergency disaster response operations. This connectivity is crucial for meeting power supply needs during crises, thereby protecting and serving societies effectively and ensuring that communities remain resilient in the face of emergencies.

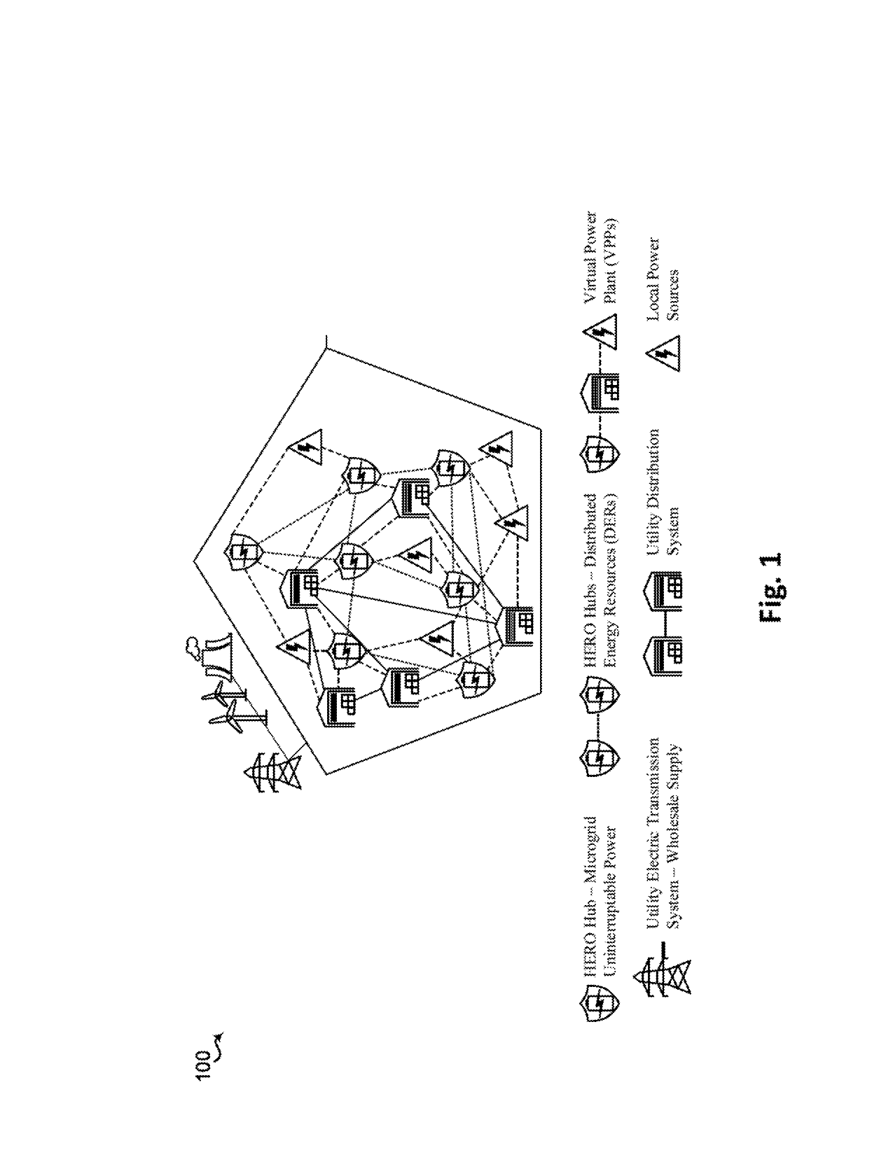

The described features will be presented in more detail below with reference to FIGS. 1-13.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

Referring to FIG. 1, is an example of a block diagram of system 100 for an utility grid network with integrated energy resources in accordance with an example embodiment. The example system 100, as depicted, represents an integration of energy resources and communication systems designed to manage power disruptions locally and enhance the performance of electric utilities. System 100 is configured for decentralization, where energy generation and management are distributed across various local nodes rather than being centralized in a few large power plants so as to improve resilience against disruptions but also optimize the efficiency and reliability of power delivery.

In an aspect, system 100 includes regional power sources that are connected to the local network via utility electric transmission systems. System 100 further includes microgrids, distributed energy resources (DERs), virtual power plants (VPPs), and local power sources interconnected amongst each other and a plurality of utility distribution systems.

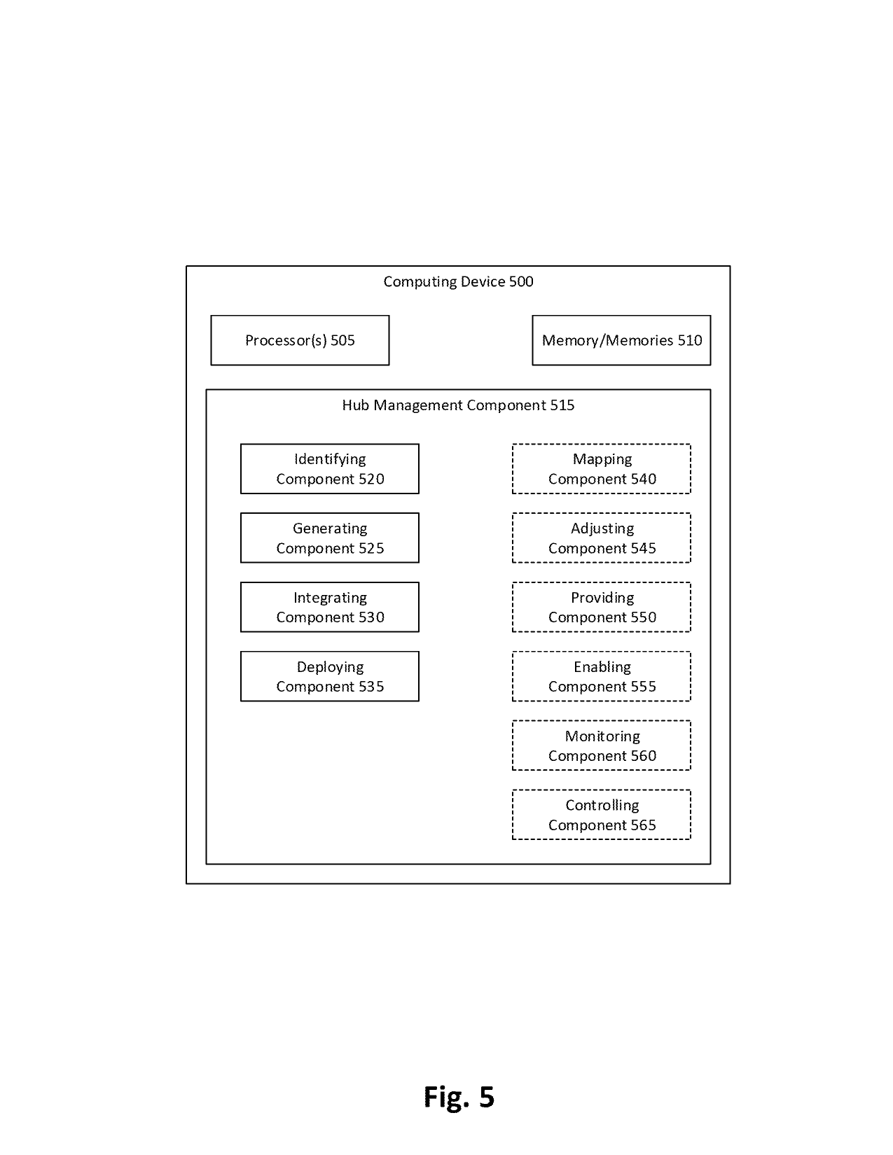

In an aspect, system 100 configured with the one or more microgrids, DERs, and VPPs may function as HERO Hubs. Microgrids are localized grids that can operate independently or in conjunction with the main power grid. Microgrids provide a reliable power supply by integrating various energy sources, such as solar panels, wind turbines, and battery storage systems, to ensure continuous electricity even during outages. DERs refer to small-scale units of local generation connected to the grid at the distribution level. These include solar panels, wind turbines, and combined heat and power systems. DERs enhance grid resilience by providing alternative power sources and reducing the load on centralized power plants. VPPs are networks of decentralized, medium-scale power generating units such as wind farms, solar parks, and combined heat and power units. These units are integrated and managed using advanced software systems to function as a single power plant, providing flexibility and reliability to the grid as further described herein in FIGS. 5-13.

In an aspect, HERO hubs are integrated with the utility distribution system and local power sources, creating a robust and flexible energy network. The system 100 facilitates a multi-directional flow of electrons, e.g., electricity or power, supported by embedded intelligent technologies. These technologies are designed to enhance the functionality of system 100 across three tiers. Tier 1 focuses on delivering 24/7 uninterruptible power which is achieved through secured access to on-site generation and storage systems, which act as emergency backup solutions. These systems ensure that critical power needs are met without interruption, even during grid failures. Tier 2 involves the rapid restoration of power following unplanned disruptions which is crucial for minimizing downtime and maintaining service continuity. Advanced sensors and automated control systems enable quick detection and response to outages, restoring power efficiently. Tier 3 encompasses demand load management functions, which are essential for balancing supply and demand on the grid. Tier 3 also delivers innovative and viable resilience capabilities for both customers and utilities. By managing energy consumption patterns and integrating renewable energy sources, the network can reduce peak demand and enhance overall grid stability.

The present system and method are designed to achieve one or a combination of technical objectives aimed at transforming the energy landscape. Primarily, system 100 provides 24/7 uninterruptable power to serve as an emergency backup, thereby mitigating risks associated with power outages. System 100 may enable the delivery and storage of electricity in a manner that is both cost-competitive and secure. Additionally, system 100 may improve the performance of utility electric grids through the implementation of advanced technologies, facilitating the transition toward a low-carbon and ultimately carbon-free grid. Moreover, system 100 may be designed to scale as a national, replicable model with viable commercialization pathways, ensuring broader adoption and sustainability.

In an aspect, system 100 is configured to deliver 24/7 uninterruptable power, modernizing utility electric grid systems, and transitioning to a carbon-free power sector. For example, system 100 incorporates data-driven electric grid performance needs assessments and modernized networks of microgrids, DERs, and/or VPPs. System 100 is configured for performance monitoring and reporting to ensure efficiency and reliability.

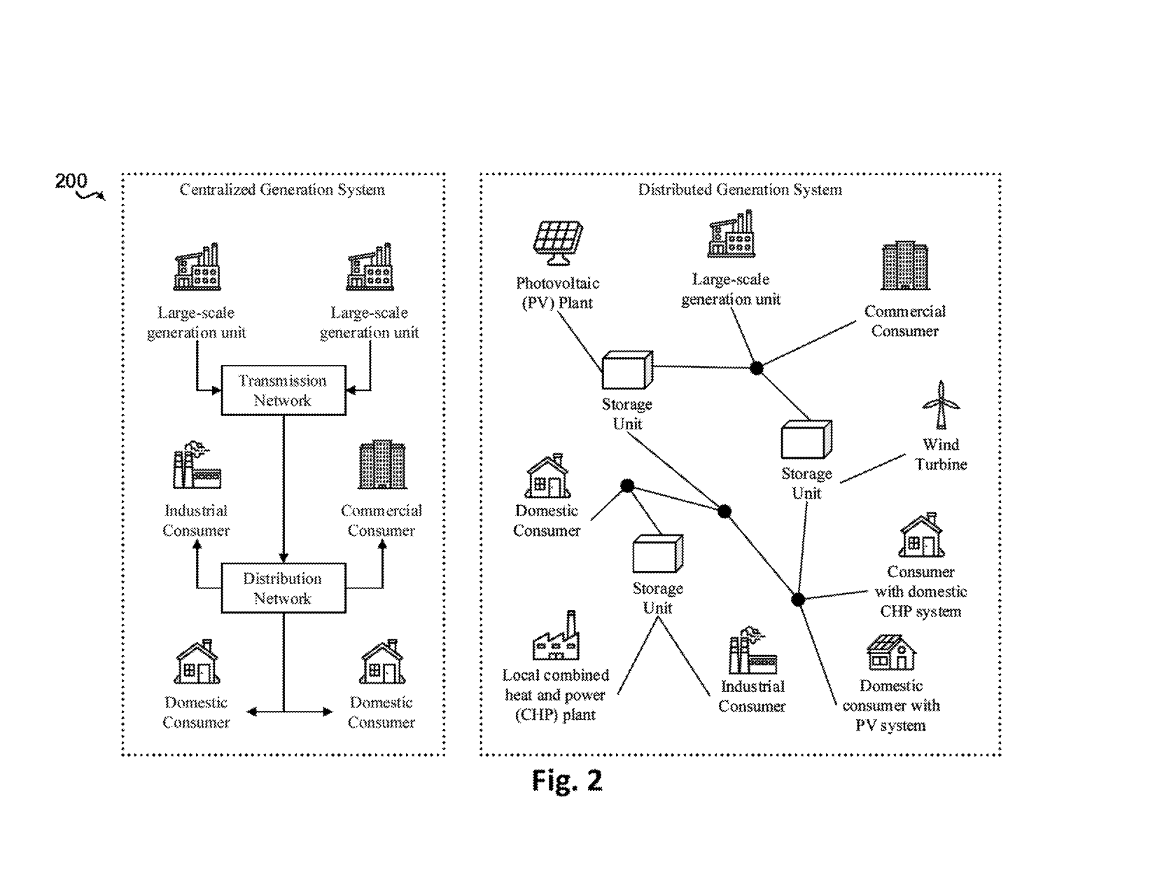

Referring to FIG. 2, is an example of a block diagram of a systems 200 including a centralized generation system and a distributed generation system in accordance with an example embodiment.

In an aspect, systems 200 provide for energy generation, distribution, and resilience, addressing the evolution from centralized to distributed energy systems. Traditional centralized generation systems rely on one-way electricity flows from large-scale facilities such as coal, gas, and nuclear power plants, with asset ownership typically under regulated utilities. Centralized systems operate within a fully regulated framework, incorporating a combination of transmission and distribution networks. Centralized systems are characterized by five components: generation, transmission, substations, distribution, and customers. Electricity is generated at significant distances from consumers and transported through high-voltage transmission systems to substations, where voltage is stepped down for distribution to customers. Despite their widespread use, centralized systems face limitations in addressing modern energy needs, particularly concerning carbon emissions and resilience during emergencies.

In an aspect, the centralized generation system may include power generation facilities, high voltage transmission lines, substations, distribution networks and back up systems. For example, power generation facilities may correspond to large-scale plants powered by fossil fuels (e.g., coal, natural gas, petroleum), nuclear energy, and, increasingly, renewable energy. These facilities are designed for high-capacity generation at specific locations, often distant from end-users. The facilities are typically utility-owned and regulated, ensuring adherence to operational standards and service reliability. High-voltage transmission lines operating at voltages of 115 kV and above, transport electricity over long distances from generation facilities to regional substations. Transmission systems are engineered to minimize power losses and maintain system stability during electricity transport.

Substations are nodes configured to step down the high voltage from transmission lines to lower levels suitable for distribution (typically ranging from 35 kV to 120V). Substations also serve as points for routing electricity toward specific distribution networks and end-users. Distribution networks comprise of low-voltage lines, the distribution system delivers power from substations to residential, commercial, and industrial customers. The hierarchical structure of distribution ensures uniform power availability across broad service areas. Backup systems ensure reliability and service continuity, backup generators or uninterruptible power supplies (UPS) are integrated at key points within the network, often near end-users. These systems are activated during outages to sustain critical loads temporarily.

In an aspect, distributed generation systems introduce multi-directional electricity flows, enabled by networks of carbon-free energy generation sites. Asset ownership in this model is diversified, with competitive consumer-owned, behind-the-meter assets playing a role. Distributed systems integrate robust and redundant grid structures alongside power stabilization and security technologies, ensuring energy resilience and security at all levels. DERs, including renewable sources, support local generation and consumption, reducing transmission losses and carbon footprints while enhancing grid flexibility.

In an aspect, distributed generation systems may include DERs, energy storage technologies, behind-the-meter assets, robust and redundant grid configuration, and control systems. Distributed energy resources (DERs) are technologies that interact with the electricity system at the distribution level. DERs either consume, store, or inject power directly into the distribution utility’s infrastructure or into an end-use customer’s system. DERs encompass renewable energy resources, energy efficiency technologies, energy storage solutions, electric vehicles, and demand response mechanisms. A further evolution of DERs is aggregated distributed energy resources (ADERs), which represent groups of DERs capable of providing grid services through coordinated dispatch or control. ADERs are managed via software that orchestrates their operations, although manual control options remain available where software interfaces are not feasible or where customers prefer direct operation.

In an aspect, ADER control methodologies include direct and customer control options. Under direct control, the program implementer retains the ability to dispatch ADERs remotely, as exemplified by customers granting utilities access to their smart thermostats or storage systems in exchange for incentives. In customer-controlled scenarios, DERs may be programmed to automatically respond to grid or price signals or manually adjusted in reaction to external inputs. This duality in control mechanisms provides flexibility and ensures broad applicability across various user preferences and infrastructure capabilities.

For example, energy storage technologies include batteries and other long-duration storage solutions that capture surplus energy for use during high-demand periods or grid outages. Storage ensures continuous energy supply and supports load balancing within the system. Behind-the-meter assets are consumer-owned assets located on the customer’s premises, such as rooftop solar panels and battery storage systems. These assets enable consumers to generate, store, and use their own electricity, contributing to grid supply when connected. Robust and redundant grid configuration incorporates multiple energy inputs and redundancies to ensure resilience. Power stabilization and security technologies, including advanced grid control systems, monitor and manage the flow of electricity, enabling multi-directional energy transfer. Control systems manage the integration and coordination of DERs, ensuring efficient energy distribution, demand response, and grid reliability. They enable real-time optimization of electricity flow and interaction with the main utility grid when needed.

Furthermore, the system integrates transmission and distribution enhancements to optimize energy delivery. High-voltage transmission systems are employed to transport electricity over long distances with minimal losses, connecting generation sites to regional substations. At the distribution level, low-voltage lines deliver electricity to end-users, ensuring accessibility and reliability. Substations play a role in stepping down voltage from transmission to distribution levels, while backup systems, including uninterruptible power supplies and localized generators, provide additional resilience.

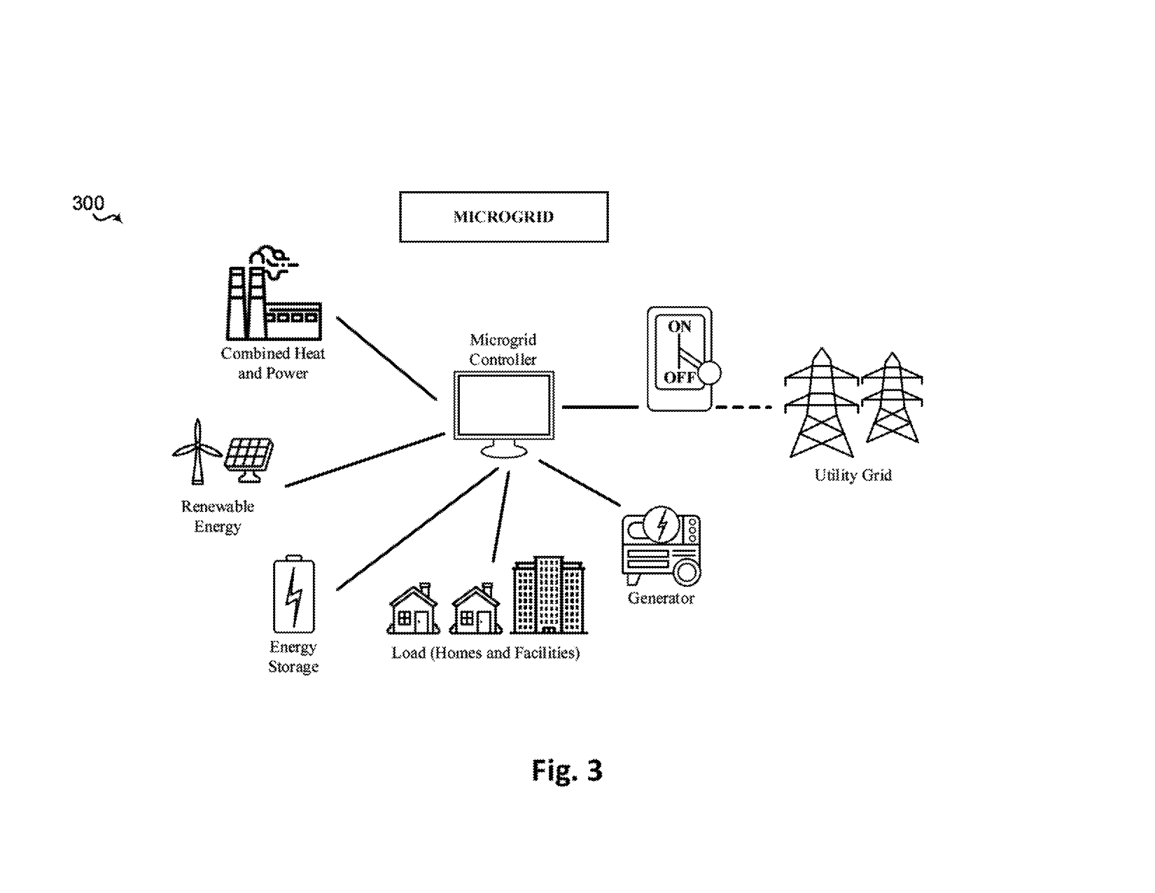

Referring to FIG. 3, is an example of a block diagram of a microgrid 300 in accordance with an example implementation. In an aspect, microgrid 300 is a group of interconnected loads and distributed energy resources operating within clearly defined electrical boundaries, functioning as a single controllable entity with respect to the grid. Microgrid(s) 300 possess the unique capability to operate either in connection with the main grid or independently in an island mode, enabling entirely off-grid applications. Components of microgrid(s) 300 include diverse electricity generation sources such as solar panels, natural gas generators, and wind turbines; long-duration energy storage technologies; and sophisticated microgrid control systems. These control systems are instrumental in coordinating distributed energy resources, managing electric loads, and ensuring seamless disconnection and reconnection to the utility electric grid distribution system.

In an aspect, microgrids are localized energy systems capable of operating independently or in conjunction with the main grid. Microgrids incorporate renewable energy sources, backup generators, and energy storage solutions to ensure continuous power delivery. They provide load support during grid outages and facilitate seamless integration with centralized grids during normal operations. The design of microgrids may be configured to account for community-specific needs and the prioritization of critical loads. Tradeoffs are inherent in this process, as resources must be allocated to balance reliability and economic feasibility effectively.

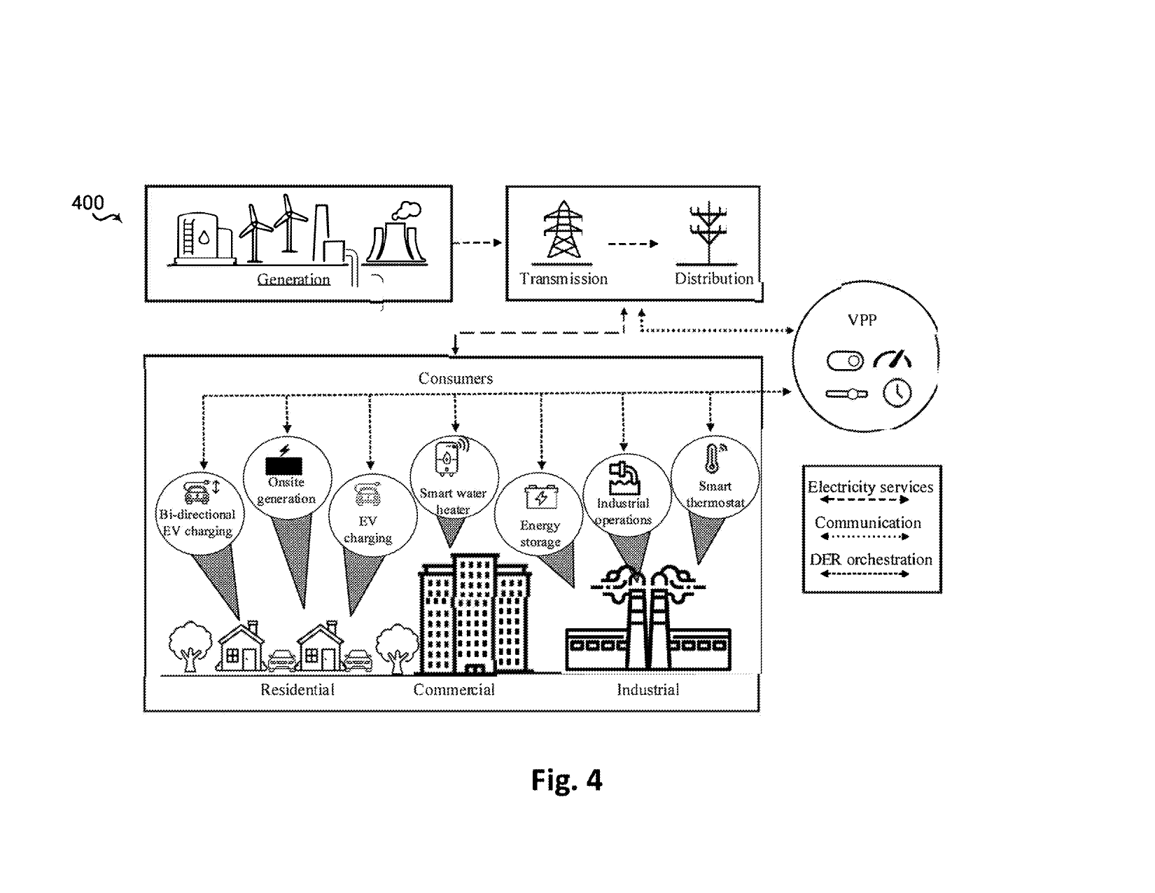

Referring to FIG. 4, is an example of a block diagram of a virtual power plant(s) (VPP(s)) 400 in accordance with an example implementation. In an aspect, VPPs and DERs may be integrated to enhance energy resilience, reduce environmental impact, and modernize grid operations. For example, VPPs may be aggregations of DERs that function as utility-scale and utility-grade grid assets, capable of balancing electrical loads and providing essential grid services akin to traditional power plants. By aggregating resources such as solar panels, battery storage systems, and other distributed generation technologies, VPPs deliver comprehensive grid services, including load balancing, peak shaving, and demand response.

In an aspect, VPPs contribute significantly to resource adequacy at a comparatively low cost, offering a flexible and scalable solution for meeting energy demands. VPPs enhance grid resilience by mitigating transmission and distribution congestion while simultaneously reducing greenhouse gas emissions and air pollution. As a modular and adaptable solution, VPPs address evolving grid requirements by integrating diverse energy resources and leveraging local DER availability to support approximately 10-20% of peak demand. However, investment in VPP programs often encounters barriers, such as regulatory-driven grid planning requirements and cost-benefit assessments, which necessitate strategic alignment and policy frameworks to promote adoption.

The implementation of VPPs is structured across three developmental stages. In Stage 1, grid modernization facilitates the integration of low-penetration DERs within existing distribution systems, requiring minimal changes to planning, infrastructure, and operations. Investments in grid modernization are pivotal during this stage to enhance reliability and resilience while accommodating future DER adoption. In Stage 2, operational markets emerge as DER penetration increases to 5-15% of the distribution system’s peak capacity. At this stage, DERs are actively utilized for load modification and generation across non-wires solutions and wholesale capacity and ancillary services, signaling a shift towards more dynamic and integrated grid operations. Stage 3 represents the full realization of VPPs, wherein DER penetration exceeds 15% of peak load, and aggregated DERs (ADERs) are orchestrated to manage a comprehensive suite of grid services across both distribution and transmission systems. This advanced stage emphasizes the role of software-driven coordination and control systems to ensure seamless integration and optimization.

In an aspect, VPPs optimize the use of distributed resources by aggregating and dispatching them in response to grid demands, reducing operational costs and improving overall system efficiency. For example, VPPs enhance the reliability of energy delivery and promote environmental sustainability by prioritizing the integration of renewable energy sources. Additionally, VPPs provide ancillary services such as frequency regulation, voltage support, and black start capabilities, ensuring robust grid performance under varying conditions. VPP deployment ensures that grid modernization aligns with DER adoption, operational market evolution, and the broader transition to a sustainable energy ecosystem. By integrating VPPs and DERs into a cohesive framework, it addresses critical challenges in energy distribution, environmental impact reduction, and grid modernization. The modular and scalable design of VPPs, coupled with their ability to provide diverse grid services, positions them as a cornerstone of the future energy landscape, enabling a seamless transition to a resilient, low-carbon, and customer-centric power system.

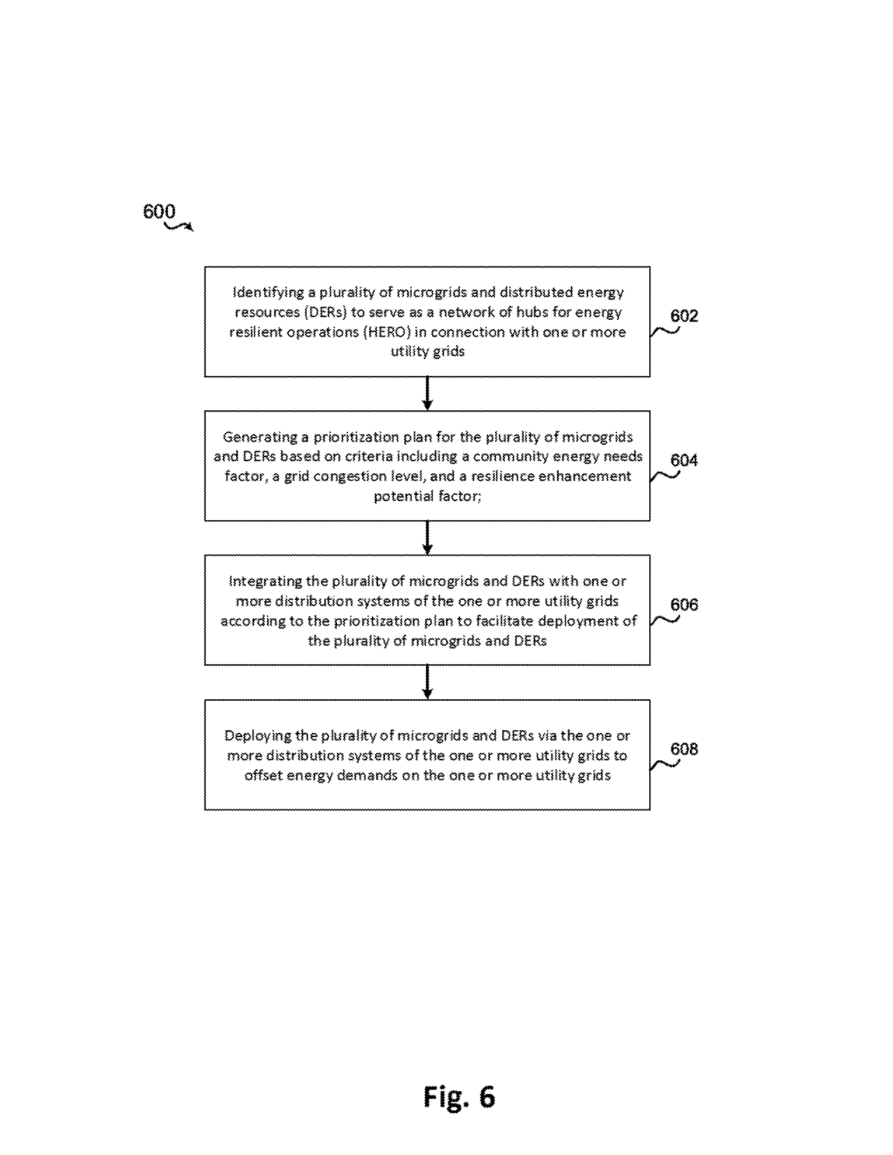

Referring to FIG. 5 and FIG. 6, in operation, computing device 500 may perform a method 600 for an integrated energy resources and communications network, such as via execution of hub management component 515 by one or more processors 505 configured, individually or in any combination, to execute instructions to perform the following actions, and/or configured to communicate with one or more memories 510 to obtain and execute the instructions.

At block 602, the method 600 includes identifying a plurality of microgrids and distributed energy resources (DERs) to serve as a network of hubs for energy resilient operations (HERO) in connection with one or more utility grids. For example, in an aspect, computing device 500, one or more processors 505, one or more memories 510, hub management component 515, and/or identifying component 520 may be configured to or may comprise means for identifying a plurality of microgrids and DERs to serve as a network of HERO in connection with one or more utility grids.

For example, the identifying at block 602 may include identifying component 520 optionally communicating with memory/memories 510 and/or an external database to access a list of microgrids and DERs. In another example, identifying component 520 may be configured to uses geospatial analysis and real-time data to identify areas with high solar and wind potential, grid congestion issues, and critical infrastructure needs. The analysis pinpoints optimal locations for deploying microgrids and DERs, creating a HERO hub network that addresses both resilience and renewable energy goals. In another example, identifying component 520 may be configured to map areas with high renewable energy adoption, such as regions with a significant number of residential solar panel installations, the utility establishes microgrids at substations that aggregate energy from these DERs.

At block 604, the method 600 includes generating a prioritization plan for the plurality of microgrids and DERs based on criteria including a community energy needs factor, a grid congestion level, and a resilience enhancement potential factor. For example, in an aspect, computing device 500, one or more processors 505, one or more memories 510, hub management component 515, and/or generating component 525 may be configured to or may comprise means for generating a prioritization plan for the plurality of microgrids and DERs based on criteria including a community energy needs factor, a grid congestion level, and a resilience enhancement potential factor.

For example, the generating at block 604 may include generating component 525 optionally communicating with memory/memories 510 and/or an external database to generate priority levels for each of the plurality of microgrids and DERs based on geographic locations, community energy needs factors, grid congestion levels, resilience enhancement potential factors, combination of criteria, emergency preparedness, equity and environmental justice factors, maximizing grid flexibility, post-disaster recovery, and economic policy incentives.

Further, for example, the generating at block 604 may be performed assigning values and weights for each category of factors. For instance, values assigned for post-disaster recovery may be weighted higher than economic and policy incentives in order to prioritize recovery efforts after a natural disaster such as a flood or tornado. Accordingly, the microgrids and DERs receive highest priority corresponding to having the highest values assigned going in descending order to the lowest priority corresponding to the lowest value assigned.

At block 606, the method 600 includes integrating the plurality of microgrids and DERs with one or more distribution systems of the one or more utility grids according to the prioritization plan to facilitate deployment of the plurality of microgrids and DERs. For example, in an aspect, computing device 500, one or more processors 505, one or more memories 510, hub management component 515, and/or integrating component 530 may be configured to or may comprise means for integrating the plurality of microgrids and DERs with one or more distribution systems of the one or more utility grids according to the prioritization plan to facilitate deployment of the plurality of microgrids and DERs.

For example, the integrating at block 606 may include integrating component 530 optionally communicating with memory/memories 510 and/or an external database to perform one or more tasks as part of the integration procedure. For instance, integrating component 530 may be configured to perform interconnection design and grid impact analysis, interoperability and communication systems, protection and safety systems, regulatory compliance and permitting, cybersecurity implementation, testing and simulation, operational planning, stakeholder coordination, and commissioning and pre-deployment validation.

Further, for example, the integrating at block 606 may be performed to simulate microgrid and DER integration into the distribution system for prioritized areas. For the interconnection design and grid impact analysis, integrating component 530 may be configured to perform a grid impact study, load flow analysis, short-circuit analysis, and power quality assessment. In another example, integrating component 530 identifies potential issues like grid imbalances or communication errors and optimizes the integration strategy to ensure smooth operations post-deployment

At block 608, the method 600 includes deploying the plurality of microgrids and DERs via the one or more distribution systems of the one or more utility grids to offset energy demands on the one or more utility grids. For example, in an aspect, computing device 500, one or more processors 505, one or more memories 510, hub management component 515, and/or deploying component 535 may be configured to or may comprise means for deploying the plurality of microgrids and DERs via the one or more distribution systems of the one or more utility grids to offset energy demands on the one or more utility grids.

For example, the deploying at block 608 may include deploying component 535 to perform one or more tasks as part of the deployment procedure. For instance, deploying component 535 may be configured to perform system activation, real-time monitoring and data exchange, demand response and energy dispatch, operational testing under live conditions, safety and protection activation, cybersecurity deployment, optimization and performance tuning, customer and stakeholder engagement, system maintenance and fault handling, long-term performance monitoring, emergency response coordination, and system updates and reconfiguration.

Further, for example, the deploying at block 608 may be performed to minimize power disruptions and costs to customers. For instance, as part of system activation, deploying component 535 may be configured to activate the microgrid and DERs, including solar panels, batteries, or generators, to begin energy production and interaction with the utility grid, and ensure the microgrid's generation sources match the utility grid’s voltage, frequency, and phase to prevent power quality issues during connection. In another instance, as part of system updates and reconfiguration, deploying component 535 may be configured to apply firmware or software updates to controllers, inverters, and EMS to enhance functionality or fix bugs, and adjust energy dispatch algorithms or load prioritization based on changes in energy demand or utility grid conditions.

In an alternative or additional aspect, an aggregation of the plurality of microgrids and DERs corresponds to a VPP configured to balance electrical loads and provide utility-scale and utility grade grid services.

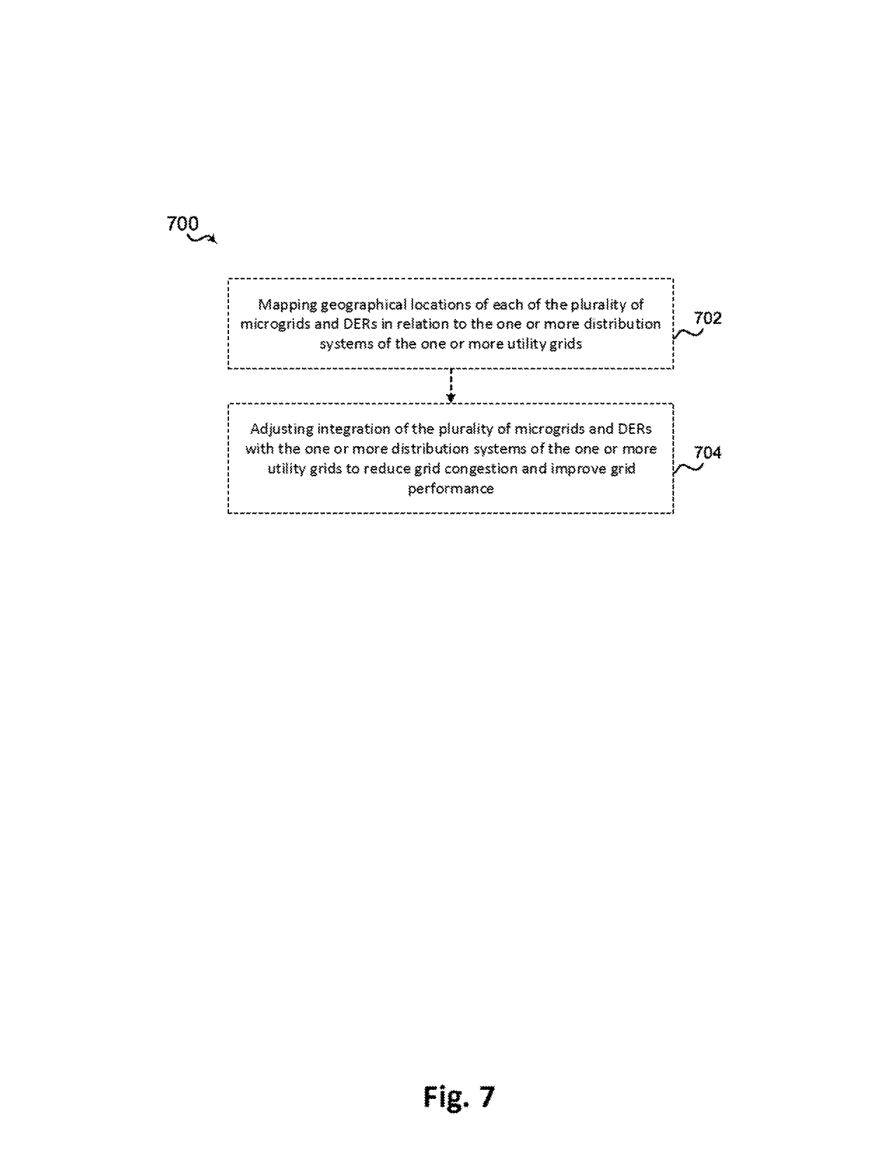

Referring to FIG. 7, in an alternative or additional aspect, at block 702, the method 600 may further include mapping geographical locations of each of the plurality of microgrids and DERs in relation to the one or more distribution systems of the one or more utility grids. For example, in an aspect, computing device 500, one or more processors 505, one or more memories 510, hub management component 515, and/or mapping component 540 may be configured to or may comprise means for mapping geographical locations of each of the plurality of microgrids and DERs in relation to the one or more distribution systems of the one or more utility grids.

For example, the mapping at block 702 may include mapping component 540 to perform one or more tasks as part of mapping the geographical locations of each of the plurality of microgrids and DERs. For instance, as part of the mapping, mapping component 540 may be configured to perform data collection, connectivity analysis, accessibility and maintenance planning, and data validation and quality assurance.

Further, for example, the mapping at block 702 may be performed to optimize connectivity and grid performance. For instance data collection may include gathering geospatial data of utility distribution systems, including substations, transmission lines, distribution feeders, and service areas; pinpointing exact geographical coordinates of microgrids, DERs (e.g., solar arrays, wind turbines, batteries), and critical load centers; and collecting information on land use, elevation, weather patterns, and environmental constraints that may affect microgrid or DER operation.

In another example, connectivity analysis may include modeling the electrical paths between microgrids, DERs, and the utility grid to identify potential interconnection points and energy flow routes; mapping energy demands in relation to the location of microgrids and DERs, ensuring sufficient capacity for load balancing and peak shaving; and identifying alternative pathways for energy flow in case of outages or equipment failure, enhancing grid resilience.

In this optional aspect, at block 704, method 600 may further include adjusting integration of the plurality of microgrids and DERs with the one or more distribution systems of the one or more utility grids to reduce grid congestion and improve grid performance. For example, in an aspect, computing device 500, one or more processors 505, one or more memories 510, hub management component 515, and/or adjusting component 545 may be configured to or may comprise means for adjusting integration of the plurality of microgrids and DERs with the one or more distribution systems of the one or more utility grids to reduce grid congestion and improve grid performance.

For example, the adjusting at block 704 may include dynamically updating and scaling the mapping of the plurality of microgrids and DERs which may alter the prioritization and integration of the plurality of microgrids and DERs with the utility grids.

Further, for example, the adjusting at block 704 may be performed to dynamically update the plurality of DER and microgrid locations as new assets are deployed or relocated. In another instance, new information such as updated hazard mapping and resilience zoning may occur that causes updates to the overall mapping of the microgrids and DERs and therefore the integration with the utility grids needs to be adjusted.

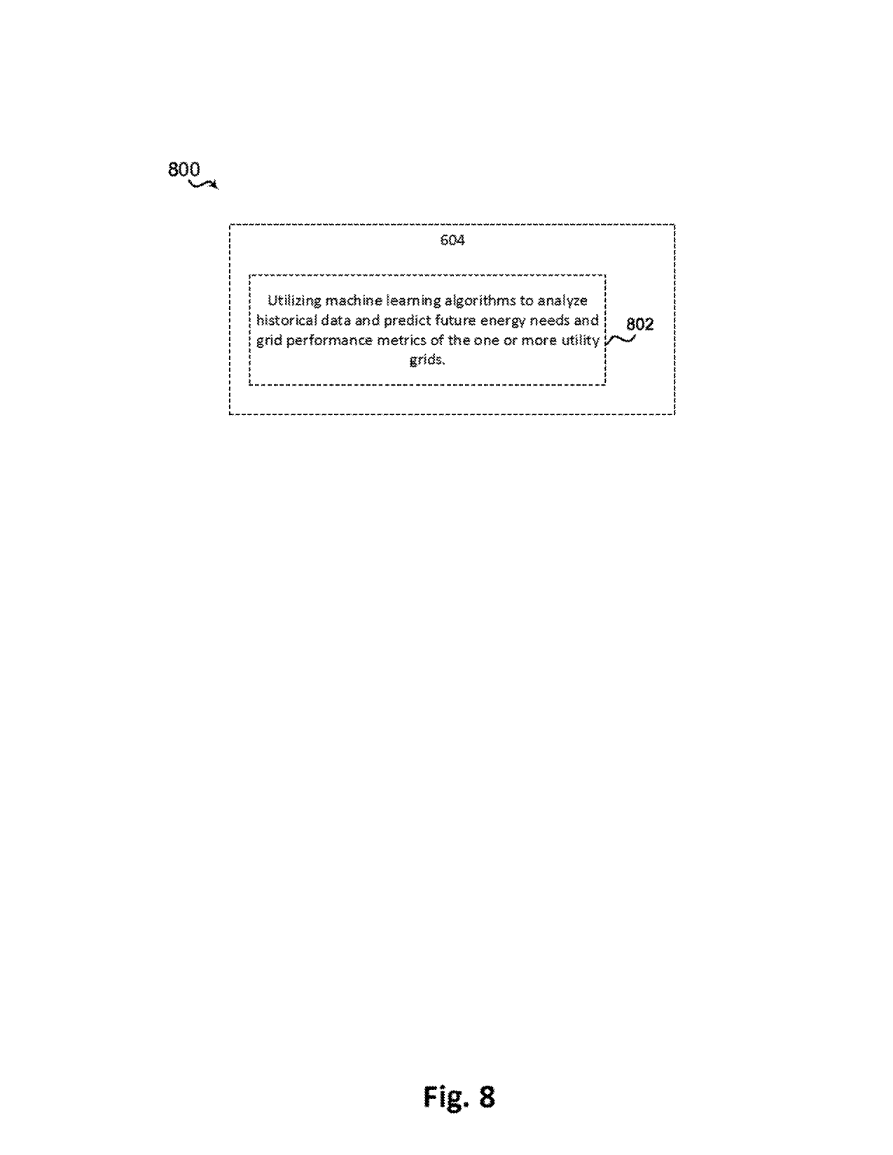

Referring to FIG. 8, in an alternative or additional aspect, at block 802, the generating at block 604 of the prioritization plan for the plurality of microgrids and DERs further comprises utilizing machine learning algorithms to analyze historical data and predict future energy needs and grid performance metrics of the one or more utility grids.

For example, generating component 525 may be configured to perform data preparation, algorithm selection, model training, and integration into utility grid operations. For instance, generating component 525 may perform data collection and preprocessing, algorithm selection, model training and validation, integration of external factors, prediction and analysis, real-time data integration, model deployment and automation, visualization and reporting, and model maintenance and improvement. In an example, generating component 525 may predict short-term, medium-term, and long-term energy demand for specific regions or grid zones, enabling utilities to plan generation and distribution effectively, analyze historical grid performance data to forecast congestion hotspots and recommend preventive actions, and identify areas prone to outages by correlating historical fault data with environmental and operational factors.

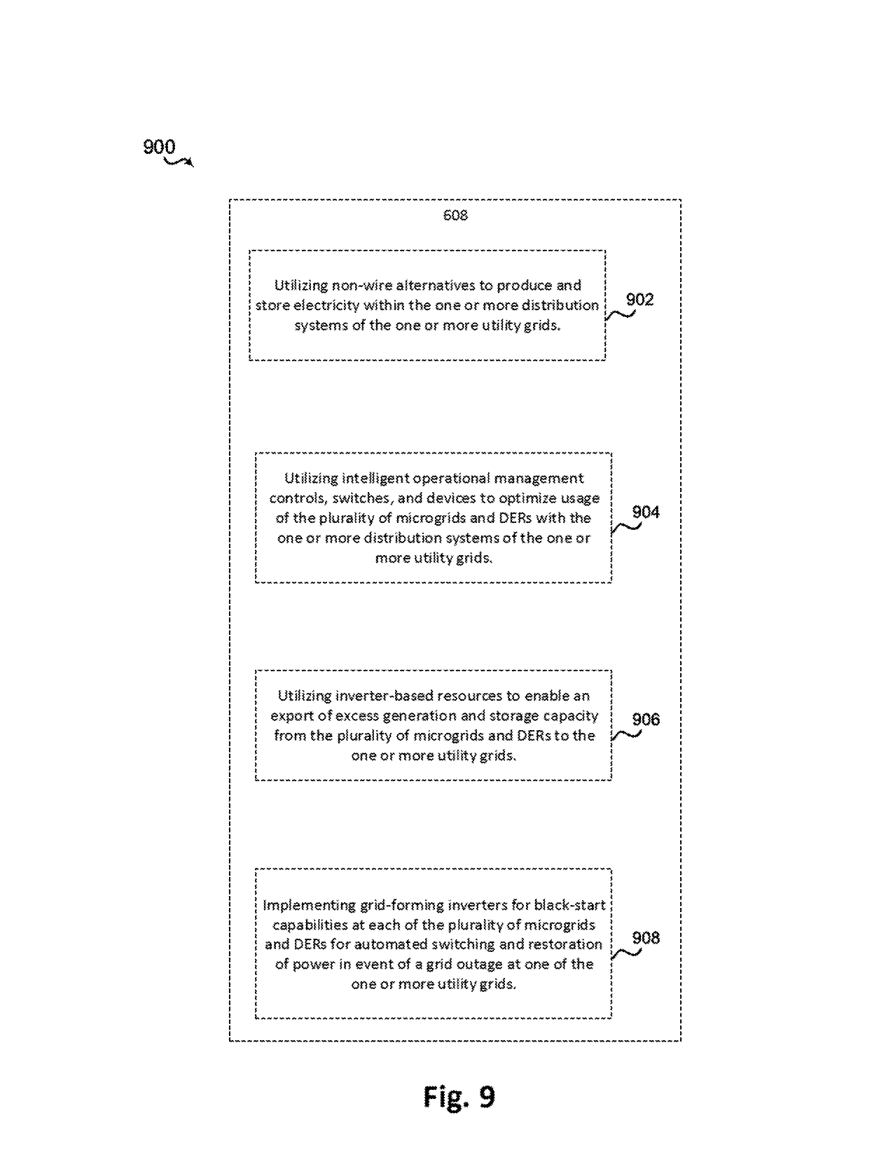

Referring to FIG. 9, in an alternative or additional aspect, at block 902, the deploying at block 608 of the plurality of microgrids and DERs further comprises utilizing non-wire alternatives (NWAs) to produce and store electricity within the one or more distribution systems of the one or more utility grids.

For example, deploying component 535 may be configured to analyze areas with high grid congestion, aging infrastructure, or significant load growth to identify locations where NWAs can replace traditional infrastructure upgrades. For instance, deploying component 535 may use historical data and predictive models to assess future demand growth and pinpoint where electricity production and storage are most needed.

At block 904, the deploying at block 608 of the plurality of microgrids and DERs further comprises utilizing intelligent operational management controls, switches, and devices to optimize usage of the plurality of microgrids and DERs with the one or more distribution systems of the one or more utility grids.

For example, deploying component 535 may be configured to install or control remotely controlled switches to manage energy flow between microgrids, DERs, and the utility grid, enabling dynamic load balancing and fault isolation. For instance, deploying component may use smart meters to provide real-time data on energy consumption, generation, and grid conditions, enhancing control over microgrid and DER performance, and implement inverters capable of managing voltage, reactive power, and frequency, ensuring seamless integration and stability across the grid.

At block 906, the deploying at block 608 of the plurality of microgrids and DERs further comprises utilizing inverter-based resources to enable an export of excess generation and storage capacity from the plurality of microgrids and DERs to the one or more utility grids.

For example, deploying component 535 may be configured to control the use of inverters, compliant with standards such as IEEE 1547 and UL 1741 SA, which govern interconnection and grid-support functionality, in grid-tied mode to enable seamless synchronization with utility grid voltage and frequency parameters. Deploying component 535 may program inverters to adjust reactive power output to maintain voltage stability and contribute to grid frequency regulation during export operations.

At block 908, the deploying at block 608 of the plurality of microgrids and DERs further comprises implementing grid-forming inverters for black-start capabilities at each of the plurality of microgrids and DERs for automated switching and restoration of power in event of a grid outage at one of the one or more utility grids.

For example, deploying component 535 may be configured to define prioritized loads that must be restored first during a blackout and configure inverters to prioritize power delivery to these loads. Further, deploying component 535 may design a staged restoration procedure where non-critical loads are added incrementally to prevent overloading the inverter or DER during the black start. Additionally, deploying component 535 may pair grid-forming inverters with appropriately sized energy storage systems to provide consistent power during the black start, and implement algorithms to maintain sufficient battery charge levels for black-start readiness at all times.

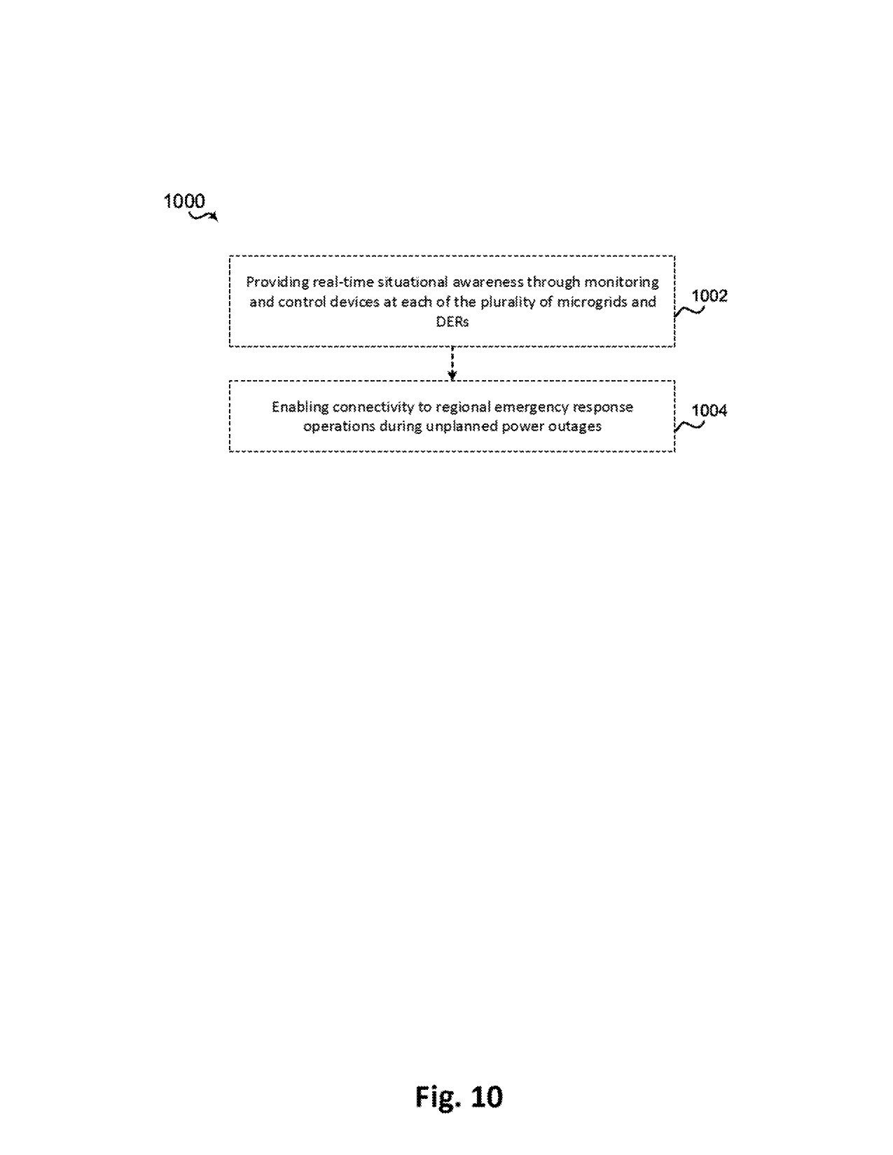

Referring to FIG. 10, in an alternative or additional aspect, at block 1002, the method 600 may further include providing real-time situational awareness through monitoring and control devices at each of the plurality of microgrids and DERs. For example, in an aspect, computing device 500, one or more processors 505, one or more memories 510, hub management component 515, and/or providing component 550 may be configured to or may comprise means for providing real-time situational awareness through monitoring and control devices at each of the plurality of microgrids and DERs.

For example, the providing at block 1002 may include providing component 550 communicating with a plurality of sensors deployed at each of the plurality of microgrids and DERs to monitor key parameters such as voltage, current, frequency, power output, state of charge (for batteries), and environmental conditions (e.g., temperature, solar irradiance). Providing component 550 may deploy advanced metering infrastructure (AMI) for real-time energy consumption and generation tracking and utilize built-in monitoring capabilities in smart inverters to track DER performance metrics such as active/reactive power and grid synchronization.

In this optional aspect, at block 1004, the method 600 may further include enabling connectivity to regional emergency response operations during unplanned power outages. For example, in an aspect, computing device 500, one or more processors 505, one or more memories 510, hub management component 515, and/or enabling component 555 may be configured to or may comprise means for enabling connectivity to regional emergency response operations during unplanned power outages.

For example, the enabling at block 1104 may include enabling component 555 to connect, via one or more wired and/or wireless communication links, emergency response centers to utility Supervisory Control and Data Acquisition (SCADA) systems for real-time monitoring of grid conditions and outage status.

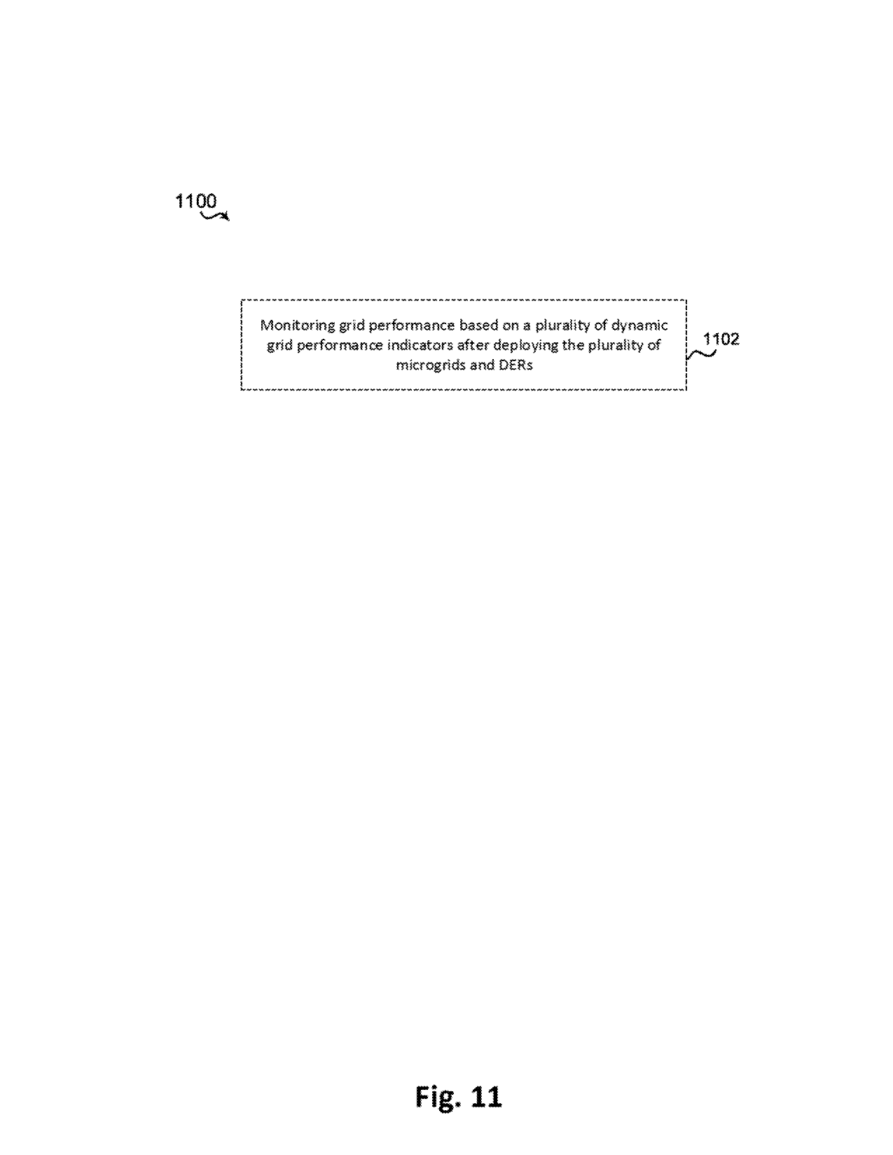

Referring to FIG. 11, in an alternative or additional aspect, at block 1102, the method 600 may further include monitoring grid performance based on a plurality of dynamic grid performance indicators after deploying the plurality of microgrids and DERs. For example, in an aspect, computing device 500, one or more processors 505, one or more memories 510, hub management component 515, and/or monitoring component 560 may be configured to or may comprise means for monitoring grid performance based on a plurality of dynamic grid performance indicators after deploying the plurality of microgrids and DERs.

For example, the monitoring at block 1402 may include monitoring component 560 to pre-deploy and/or control and/or communicate with advanced metering infrastructure (AMI) to track energy usage, generation, and grid health at individual customer and DER sites and use phasor measurement units (PMUs) for high-resolution monitoring of grid stability indicators such as voltage phase angles and frequency variations.

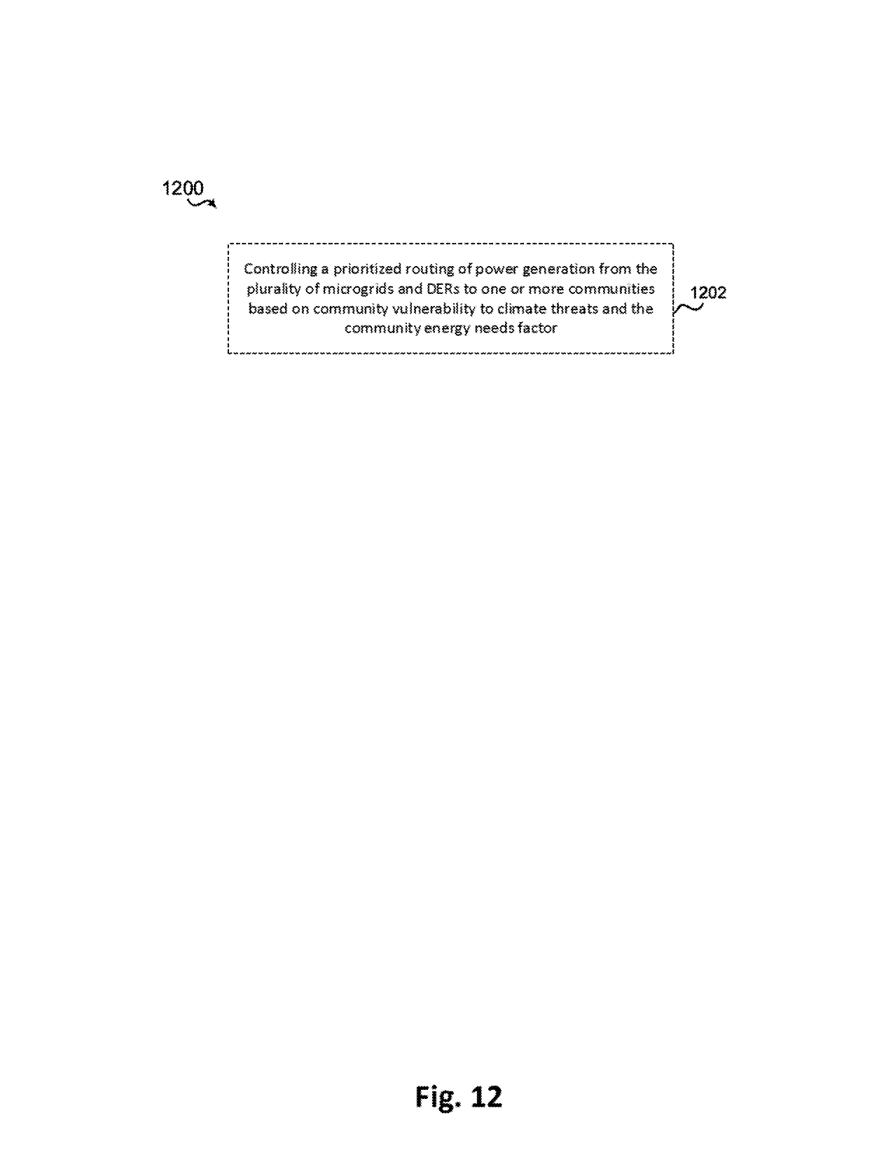

Referring to FIG. 12, in an alternative or additional aspect, at block 1202, the method 600 may further include controlling a prioritized routing of power generation from the plurality of microgrids and DERs to one or more communities based on community vulnerability to climate threats and the community energy needs factor. For example, in an aspect, computing device 500, one or more processors 505, one or more memories 510, hub management component 515, and/or controlling component 565 may be configured to or may comprise means for controlling a prioritized routing of power generation from the plurality of microgrids and DERs to one or more communities based on community vulnerability to climate threats and the community energy needs factor.

For example, the controlling at block 1202 may include controlling component 565 configured to develop algorithms to rank communities based on vulnerability indices (e.g., climate risk scores) and energy needs factors (e.g., critical infrastructure requirements). Controlling component 565 may enable algorithms to adjust priorities in real-time, e.g., change a weighted-value, based on evolving factors such as weather forecasts, outages, or grid conditions.

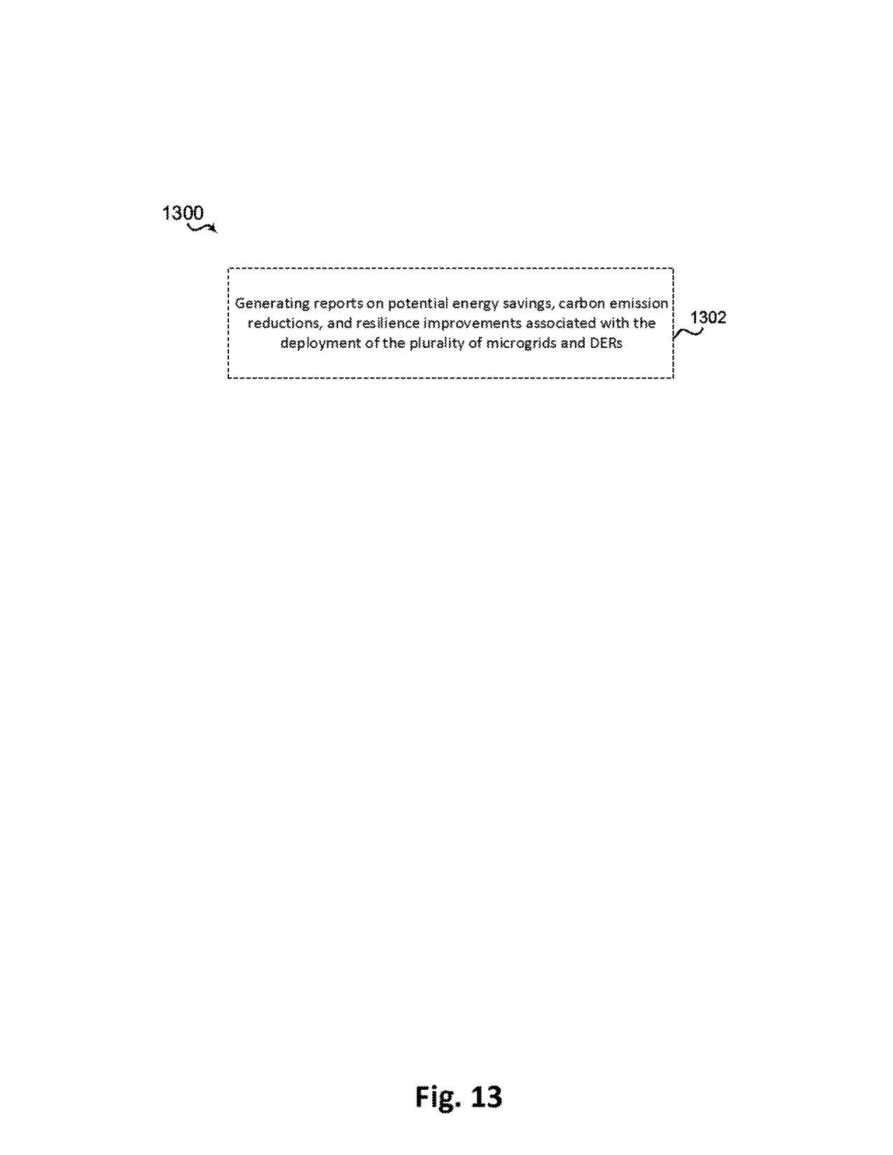

Referring to FIG. 13, in an alternative or additional aspect, at block 1302, the method 600 may further include generating reports on potential energy savings, carbon emission reductions, and resilience improvements associated with the deployment of the plurality of microgrids and DERs. For example, in an aspect, computing device 500, one or more processors 505, one or more memories 510, hub management component 515, and/or generating component 525 may be configured to or may comprise means for generating reports on potential energy savings, carbon emission reductions, and resilience improvements associated with the deployment of the plurality of microgrids and DERs.

For example, the generating at block 1302 may include generating component 525 to gather data from smart meters, SCADA systems, and DER management systems on energy production and usage, collect data on fuel types, usage, and emissions factors for DERs and replaced traditional energy sources, record instances of grid outages, DER or microgrid activations, and power restoration times, and use climate and weather data to model how DERs and microgrids mitigate climate-related risks. In a further instance, generating component 525 may be configured to generate dynamic dashboards, data visualization tools, and scenario reporting on potential energy savings, carbon emission reductions, and resilience improvements associated with the deployment of the plurality of microgrids and DERs.

### SOME ADDITIONAL EXAMPLES

The aspects described herein additionally include one or more of the following aspect examples described in the following numbered clauses.

Clause 1. A method for an integrated energy resources and communications network, comprising: identifying a plurality of microgrids and distributed energy resources (DERs) to serve as a network of hubs for energy resilient operations (HERO) in connection with one or more utility grids; generating a prioritization plan for the plurality of microgrids and DERs based on criteria including a community energy needs factor, a grid congestion level, and a resilience enhancement potential factor; integrating the plurality of microgrids and DERs with one or more distribution systems of the one or more utility grids according to the prioritization plan to facilitate deployment of the plurality of microgrids and DERs; and deploying the plurality of microgrids and DERs via the one or more distribution systems of the one or more utility grids to offset energy demands on the one or more utility grids.

Clause 2. The method of clause 1, wherein an aggregation of the plurality of microgrids and DERs corresponds to a virtual power plant (VPP) configured to balance electrical loads and provide utility-scale and utility grade grid services.

Clause 3. The method of clause 1, further comprising: mapping geographical locations of each of the plurality of microgrids and DERs in relation to the one or more distribution systems of the one or more utility grids; and adjusting integration of the plurality of microgrids and DERs with the one or more distribution systems of the one or more utility grids to reduce grid congestion and improve grid performance.

Clause 4. The method of clause 1, wherein generating the prioritization plan for the plurality of microgrids and DERs further comprises utilizing machine learning algorithms to analyze historical data and predict future energy needs and grid performance metrics of the one or more utility grids.

Clause 5. The method of clause 1, wherein deploying the plurality of microgrids and DERs further comprises utilizing non-wire alternatives to produce and store electricity within the one or more distribution systems of the one or more utility grids.

Clause 6. The method of clause 1, wherein deploying the plurality of microgrids and DERs further comprises utilizing intelligent operational management controls, switches, and devices to optimize usage of the plurality of microgrids and DERs with the one or more distribution systems of the one or more utility grids.

Clause 7. The method of clause 1, further comprising: providing real-time situational awareness through monitoring and control devices at each of the plurality of microgrids and DERs; and enabling connectivity to regional emergency response operations during unplanned power outages.

Clause 8. The method of clause 1, wherein deploying the plurality of microgrids and DERs further comprises utilizing inverter-based resources to enable an export of excess generation and storage capacity from the plurality of microgrids and DERs to the one or more utility grids.

Clause 9. The method of clause 1, wherein deploying the plurality of microgrids and DERs further comprises implementing grid-forming inverters for black-start capabilities at each of the plurality of microgrids and DERs for automated switching and restoration of power in event of a grid outage at one of the one or more utility grids.

Clause 10. The method of clause 1, further comprising: monitoring grid performance based on a plurality of dynamic grid performance indicators after deploying the plurality of microgrids and DERs.

Clause 11. The method of clause 1, further comprising: controlling a prioritized routing of power generation from the plurality of microgrids and DERs to one or more communities based on community vulnerability to climate threats and the community energy needs factor.

Clause 12. The method of clause 1, further comprising: generating reports on potential energy savings, carbon emission reductions, and resilience improvements associated with the deployment of the plurality of microgrids and DERs.

Clause 13. An apparatus for an integrated energy resources and communications network, comprising: one or more memories; and one or more processors coupled with one or more memories and configured, , individually or in combination, to: identify a plurality of microgrids and distributed energy resources (DERs) to serve as a network of hubs for energy resilient operations (HERO) in connection with one or more utility grids; generate a prioritization plan for the plurality of microgrids and DERs based on criteria including a community energy needs factor, a grid congestion level, and a resilience enhancement potential factor; integrate the plurality of microgrids and DERs with one or more distribution systems of the one or more utility grids according to the prioritization plan to facilitate deployment of the plurality of microgrids and DERs; and deploy the plurality of microgrids and DERs via the one or more distribution systems of the one or more utility grids to offset energy demands on the one or more utility grids.

Clause 14. The apparatus of clause 13, wherein an aggregation of the plurality of microgrids and DERs corresponds to a virtual power plant (VPP) configured to balance electrical loads and provide utility-scale and utility grade grid services.

Clause 15. The apparatus of clause 13, wherein the one or more processors are further configured to: map geographical locations of each of the plurality of microgrids and DERs in relation to the one or more distribution systems of the one or more utility grids; and adjust integration of the plurality of microgrids and DERs with the one or more distribution systems of the one or more utility grids to reduce grid congestion and improve grid performance.

Clause 16. The apparatus of clause 13, wherein to generate the prioritization plan for the plurality of microgrids and DERs the one or more processors are further configured to utilize machine learning algorithms to analyze historical data and predict future energy needs and grid performance metrics of the one or more utility grids.

Clause 17. The apparatus of clause 13, wherein to deploy the plurality of microgrids and DERs the one or more processors are further configured to utilize non-wire alternatives to produce and store electricity within the one or more distribution systems of the one or more utility grids.

Clause 18. The apparatus of clause 13, wherein to deploy the plurality of microgrids and DERs the one or more processors are further configured to utilize intelligent operational management controls, switches, and devices to optimize usage of the plurality of microgrids and DERs with the one or more distribution systems of the one or more utility grids.

Clause 19. The apparatus of clause 13, wherein the one or more processors are further configured to: provide real-time situational awareness through monitoring and control devices at each of the plurality of microgrids and DERs; and enable connectivity to regional emergency response operations during unplanned power outages.

Clause 20. The apparatus of clause 13, wherein to deploy the plurality of microgrids and DERs the one or more processors are further configured to utilize inverter-based resources to enable an export of excess generation and storage capacity from the plurality of microgrids and DERs to the one or more utility grids.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for an integrated energy resources and communications network, comprising:
identifying a plurality of microgrids and distributed energy resources (DERs) to serve as a network of hubs for energy resilient operations (HERO) in connection with one or more utility grids;
generating a prioritization plan for the plurality of microgrids and DERs based on criteria including a community energy needs factor, a grid congestion level, and a resilience enhancement potential factor;
integrating the plurality of microgrids and DERs with one or more distribution systems of the one or more utility grids according to the prioritization plan to facilitate deployment of the plurality of microgrids and DERs; and
deploying the plurality of microgrids and DERs via the one or more distribution systems of the one or more utility grids to offset energy demands on the one or more utility grids.

2. The method of claim 1, wherein an aggregation of the plurality of microgrids and DERs corresponds to a virtual power plant (VPP) configured to balance electrical loads and provide utility-scale and utility grade grid services.

3. The method of claim 1, further comprising:
mapping geographical locations of each of the plurality of microgrids and DERs in relation to the one or more distribution systems of the one or more utility grids; and
adjusting integration of the plurality of microgrids and DERs with the one or more distribution systems of the one or more utility grids to reduce grid congestion and improve grid performance.

4. The method of claim 1, wherein generating the prioritization plan for the plurality of microgrids and DERs further comprises utilizing machine learning algorithms to analyze historical data and predict future energy needs and grid performance metrics of the one or more utility grids.

5. The method of claim 1, wherein deploying the plurality of microgrids and DERs further comprises utilizing non-wire alternatives to produce and store electricity within the one or more distribution systems of the one or more utility grids.

6. The method of claim 1, wherein deploying the plurality of microgrids and DERs further comprises utilizing intelligent operational management controls, switches, and devices to optimize usage of the plurality of microgrids and DERs with the one or more distribution systems of the one or more utility grids.

7. The method of claim 1, further comprising:
providing real-time situational awareness through monitoring and control devices at each of the plurality of microgrids and DERs; and
enabling connectivity to regional emergency response operations during unplanned power outages.

8. The method of claim 1, wherein deploying the plurality of microgrids and DERs further comprises utilizing inverter-based resources to enable an export of excess generation and storage capacity from the plurality of microgrids and DERs to the one or more utility grids.

9. The method of claim 1, wherein deploying the plurality of microgrids and DERs further comprises implementing grid-forming inverters for black-start capabilities at each of the plurality of microgrids and DERs for automated switching and restoration of power in event of a grid outage at one of the one or more utility grids.

10. The method of claim 1, further comprising:
monitoring grid performance based on a plurality of dynamic grid performance indicators after deploying the plurality of microgrids and DERs.

11. The method of claim 1, further comprising:
controlling a prioritized routing of power generation from the plurality of microgrids and DERs to one or more communities based on community vulnerability to climate threats and the community energy needs factor.

12. The method of claim 1, further comprising:
generating reports on potential energy savings, carbon emission reductions, and resilience improvements associated with the deployment of the plurality of microgrids and DERs.

13. An apparatus for an integrated energy resources and communications network, comprising:
one or more memories; and
one or more processors coupled with one or more memories and configured, , individually or in combination, to:
identify a plurality of microgrids and distributed energy resources (DERs) to serve as a network of hubs for energy resilient operations (HERO) in connection with one or more utility grids;
generate a prioritization plan for the plurality of microgrids and DERs based on criteria including a community energy needs factor, a grid congestion level, and a resilience enhancement potential factor;
integrate the plurality of microgrids and DERs with one or more distribution systems of the one or more utility grids according to the prioritization plan to facilitate deployment of the plurality of microgrids and DERs; and
deploy the plurality of microgrids and DERs via the one or more distribution systems of the one or more utility grids to offset energy demands on the one or more utility grids.

14. The apparatus of claim 13, wherein an aggregation of the plurality of microgrids and DERs corresponds to a virtual power plant (VPP) configured to balance electrical loads and provide utility-scale and utility grade grid services.

15. The apparatus of claim 13, wherein the one or more processors are further configured to:
map geographical locations of each of the plurality of microgrids and DERs in relation to the one or more distribution systems of the one or more utility grids; and
adjust integration of the plurality of microgrids and DERs with the one or more distribution systems of the one or more utility grids to reduce grid congestion and improve grid performance.

16. The apparatus of claim 13, wherein to generate the prioritization plan for the plurality of microgrids and DERs the one or more processors are further configured to utilize machine learning algorithms to analyze historical data and predict future energy needs and grid performance metrics of the one or more utility grids.

17. The apparatus of claim 13, wherein to deploy the plurality of microgrids and DERs the one or more processors are further configured to utilize non-wire alternatives to produce and store electricity within the one or more distribution systems of the one or more utility grids.

18. The apparatus of claim 13, wherein to deploy the plurality of microgrids and DERs the one or more processors are further configured to utilize intelligent operational management controls, switches, and devices to optimize usage of the plurality of microgrids and DERs with the one or more distribution systems of the one or more utility grids.

19. The apparatus of claim 13, wherein the one or more processors are further configured to:
provide real-time situational awareness through monitoring and control devices at each of the plurality of microgrids and DERs; and
enable connectivity to regional emergency response operations during unplanned power outages.

20. The apparatus of claim 13, wherein to deploy the plurality of microgrids and DERs the one or more processors are further configured to utilize inverter-based resources to enable an export of excess generation and storage capacity from the plurality of microgrids and DERs to the one or more utility grids.
